(19) United States
(12) Patent Application Publication
(10) Pub. No.: US 2003/0237013 A1
(43) Pub. Date: Dec. 25, 2003

(54) Method and apparatus for providing clocks for network equipment

(76) Inventors: Yaohui Xie, Shenzhen City (CN); Donghai Yu, Shenzhen City (CN); Chongyang Wang, Shenzhen City (CN)

Correspondence Address: SCHIFF HARDIN & WAITE, 6600 SEARS TOWER, 233 S WACKER DR, CHICAGO, IL, 60606-6473, US

(21) Appl. No.: 10/439,482

(22) Filed: May 16, 2003

(30) Foreign Application Priority Data
May 22, 2002 (CN) 02117845.3

(51) Int. Cl. G06F 1/06

(52) U.S. Cl. 713/500

(57) ABSTRACT

The present invention relates to a method and apparatus for providing clocks for network equipment. According to the method, clock input signals are first received from a primary and a redundant system; the clock input signal is then selected from the primary system; the selected clock input signal from the primary system is distributed to the interfaces needing a clock signal in the network equipment, respectively. The apparatus comprises a clock input selection module and a clock input distributing module. The clock input selection module selects the clock input signal received from the primary system, and the clock input signal from the primary system is then sent to the clock input distributing module. The clock input distributing module distributes the received clock input signal and outputs the distributed signal. According to the present invention, when the primary system is replaced by the redundant system in the network equipment, the reliability of inputting a clock signal to corresponding interfaces of the network equipment can still be ensured, and thus the network equipment can satisfy performance requirement of telecommunication equipment.

### BACKGROUND OF THE INVENTION

1. Field of the Invention

The present invention relates to a method and apparatus for providing clocks for network equipment in a network communication system, and more particularly to a method and apparatus for providing clocks for network equipment in which the clocks are provided by primary and redundant modules.

2. Background of the Invention

To maintain the reliability of network equipment in a network communication system, one primary module and one redundant backup module are usually used for the important modules of key network processing equipment. For example, two switch modules, namely a primary switch module and a redundant switch module, are provided in a key router. The two switch modules are respectively connected to two DASL (Data-Aligned Synchronous Link) interfaces of each NP (Network Processor) of the network communication system. When one of the switch modules is down, the other switch module can be switched in to replace the troubled switch module for maintaining normal processing of the key router.

As is shown in FIG. 1, each network processor NP has two interfaces, i.e. DASL A and DASL B, which are used to connect to corresponding interfaces of two switch modules, i.e., Switch A and Switch B. Clocks needed by the two DASL interfaces of the network processors NP are respectively provided by the switch modules Switch A and Switch B. As a matter of nomenclature, in 1:1 mode, either of the switch modules Switch A and Switch B may be designated as the primary module and the other of the switch modules Switch A and Switch B may be designated as the redundant module; and in 1+1 mode, the primary module is the module which is in the working state. However, for convenience, the switch module Switch A will be designated herein as the primary module.

At present, when the primary and redundant modules of the network processors NP work normally, the clocks needed by the two DASL interfaces of the network processors NP are respectively provided by the two switch modules as shown in FIG. 1. But when the primary module, i.e., the switch module Switch A, is down, it is necessary to replace the primary module by the redundant module. Accordingly, all traffic is switched to the other redundant switch module, i.e., the switch module Switch B. At the same time, the switch module Switch A needs to be unplugged for repair or replacement.

When the switch module Switch A is down, the DASL A interfaces of the network processors NP will lose their clocks and, when all traffic is switched to the switch module Switch B, the DASL B interfaces of the network processors NP will receive their clocks. The loss of clocks to the DASL A interfaces of the network processors NP will cause an abnormal working state of the network processors NP, and the next replacement between the primary module and the redundant module will be hard to realize. Therefore, the prior method for providing clocks for network equipment cannot satisfy performance requirement of telecommunication equipment at all.

### SUMMARY OF THE INVENTION

The present invention is directed to a method and apparatus for providing clocks for network equipment so as to ensure that clocks can be provided normally for network equipment when the primary system is replaced by the redundant system, and to satisfy performance requirements of telecommunication network equipment.

Accordingly, a method for providing clocks for network equipment comprises: (1) receiving clock input signals from a primary and a redundant system; (2) selecting the clock input signal from the primary system; (3) distributing the clock input signal from the primary system to feed to the interfaces needing clock signal in the network equipment respectively.

In a more detailed aspect of the method, the clock input signal from the primary system is selected and received according to a primary state signal provided by the primary system and the redundant system.

The apparatus for providing clocks to network equipment comprises a clock input selection module and a clock input distributing module. The clock input selection module provides an input interface to receive clock input signal from the primary or the redundant system, then selects the clock input signal received from the primary system. The selected clock input signal is sent to the clock input distributing module, and the clock input distributing module distributes the received clock input signal and outputs the distributed signals.

In more detailed aspects of the apparatus, the clock input selection module connects to the clock selection control module, the clock selection control module generates and sends the clock selection control signal to the clock input selection module. The clock selection control module generates the clock selection control signal according to the state signal from the primary and the redundant system. The clock input selection module may comprise a SY100EL56V chip, and the clock input distributing module may comprise a SY100EL11V chip.

As can be seen from the above, in the present invention, after the clock input signal from the primary system in the normal working state is processed, the clock input is provided for corresponding interfaces of network equipment. Thus, after primary-redundant replacement happens between the primary and redundant systems of network equipment, reliability of inputting clock signal for corresponding interface can still be ensured. The present invention fundamentally overcomes the problem that the redundant module cannot provide the clock input for the corresponding interface after the primary module is replaced in prior art. Thus, reliability of the whole network equipment can be ensured with the present invention, and the network equipment can satisfy the performance requirements of telecommunication equipment.

### BRIEF DESCRIPTION OF THE DRAWINGS

FIG. 1 is the structural diagram of a key router composed of network processors;

FIG. 2 is a flowchart of a method for providing the clock for network equipment;

FIG. 3 is the structural diagram of an apparatus for providing the clock for network processors;

FIG. 4 is a circuit schematic drawing of the apparatus of FIG. 3 for providing the clock for network processors.

### PREFERRED EMBODIMENT OF THE INVENTION

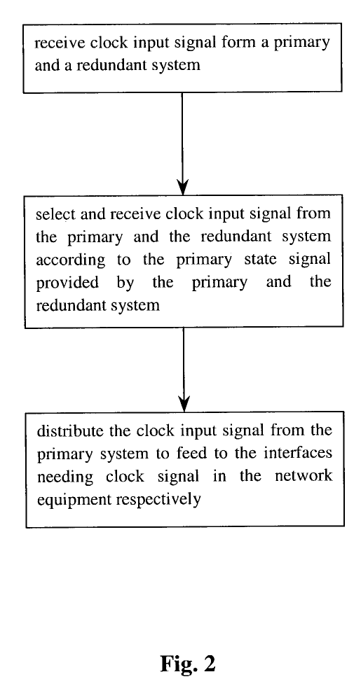

A detailed implementing process of the method for providing the clock for network equipment according to the present invention is described as follows, referring to FIG. 2:

Step 1: receive the clock input signals from a primary and a redundant system of network equipment;

Step 2: select the clock input signal from the primary system from the two input signals according to a primary state signal provided by the primary and redundant system, i.e., select the clock input signal of the system in the working state to ensure that the clock input signal can be received reliably; and,

Step 3: distribute the clock input signal from the primary system to the interfaces needing the clock signal in the network equipment respectively, usually the clock input signal needs to be distributed to two channels to provide for the clock input interface of the network equipment.

Through this process, the clock input signal can be reliably provided for the clock input interfaces of the network equipment. Therefore, reliability of the network equipment is maintained.

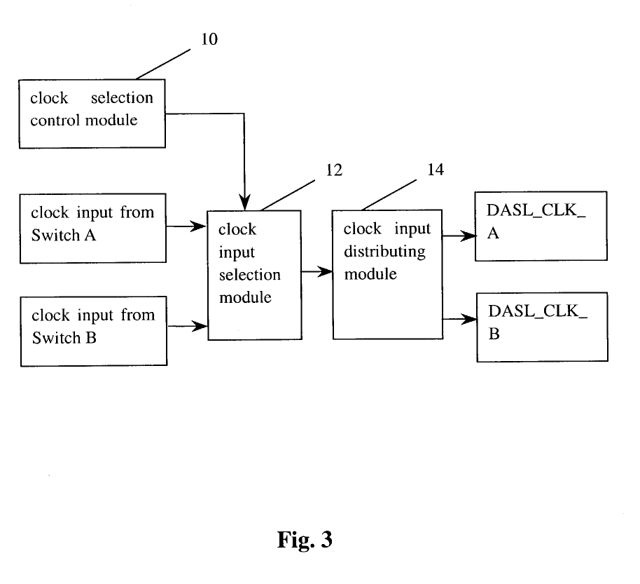

The apparatus for providing the clock for each of the network processors NP according to the present invention is designed according to the method for providing the clock for the network equipment and the key router composed of the network processors NP. The detailed embodiment of this apparatus is described as follows, referring to FIG. 3.

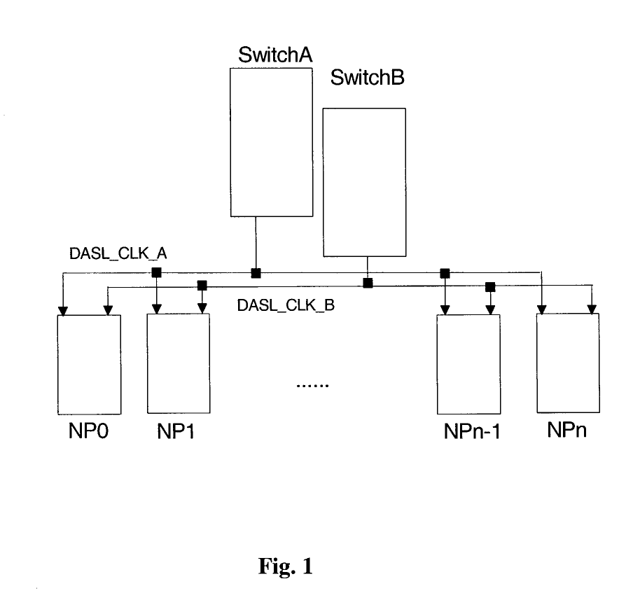

The apparatus for providing the clock for the equipment of a network processor comprises a clock selection control module 10, a clock input selection module 12, and a clock input distributing module 14. The three modules can be either in the peripheral circuit board where NP exists or inside chip NP. The clock input selection module 12 connects to the clock selection control module 10, and the clock selection control module 10 generates and sends the clock selection control signal to the clock input selection module 12. The clock input selection module 12 provides an input interface to receive the clock input signals from the primary and the redundant modules such as the switch modules Switch A and Switch B of FIG. 1. This input interface is used to receive the clock input signal from the switch module Switch A and the clock input signal from the switch module Switch B. After the two clock input signals are received, the clock input selection module 12 selects the clock input signal from the primary system according to the clock selection control signal provided by clock selection control module 10, and the clock input selection module 12 sends the selected clock input signal to the clock input distributing module 14. The clock input distributing module 14 distributes the selected clock input signal from the primary system to two channels and outputs them. That is, the output clock signals are respectively provided to the clock input interface of DASL A of the network processor NP and to the clock input interface of DASL B of the network processor NP.

This apparatus provides the clock input signal to the clock input interface of network equipment. Therefore, as long as the primary switch module exists, the two DASL interfaces of the network processor NP can obtain the clock input signal reliably. The present invention avoids the problem that a DASL interface of a network processor NP loses clock for a long time when a switch module is pulled out and another is inserted or when only one switch module works properly.

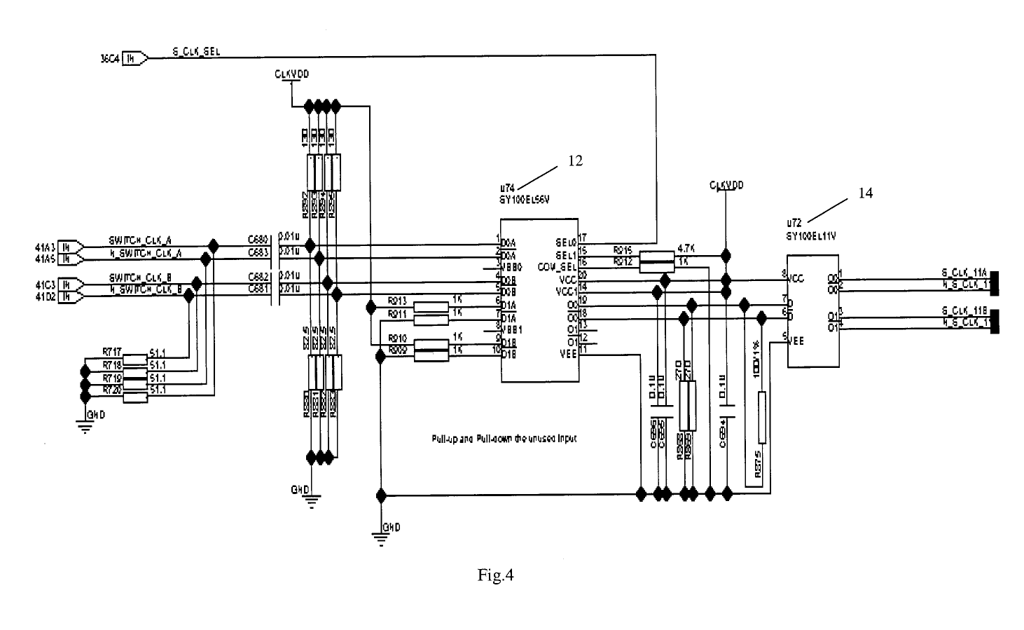

Referring to FIG. 4, the detailed embodiment of the apparatus of FIG. 3 for providing clocks to network equipment will now be described in further detail. As shown in FIG. 4, a chip SY100EL56V is used as the clock input selection module 12, which can select the clock from the primary switch module from the two clock input signals provided by the two switch modules Switch A and Switch B. The two clock input signals are SWITCH_CLK_A and SWITCH_CLK_B, and these two clock input signals from the two switch modules are respectively connected to pins 1, 2 and to pins 4, 5. The clock selection control signal S_CLK_SEL is decoded by a state machine integrated in the same circuit board with the network processor NP according to primary signals of the two switch modules and is output. The clock selection control signal S_CLK_SEL is input to pin 17 of the chip SY100EL56V, and the clock selection control signal S_CLK_SEL is used to select the clock input signal from the primary system in cooperation with SY100EL56V. A chip SY100EL11V is the clock input distributing module 14, which receives the clock input signal from the primary switch module selected by the chip SY100EL56V and distributes it over two channels to the two interfaces of the network processor NP. The chips SY100EL11V and SY100EL56V may be supplied, for example, by Synergy Semiconductor Corporation.

What is claimed is:

1. A method for providing clocks to network equipment comprising:
(1) receiving clock input signals from a primary and a redundant system;
(2) selecting the clock input signal from the primary system; and,
(3) distributing the selected clock input signal from the primary system to interfaces needing a clock signal of the network equipment, respectively.

2. The method of claim 1, wherein step (2) comprises selecting and receiving the clock input signal from the primary system according to a primary state signal provided by the primary system and the redundant system.

3. An apparatus for providing clocks to network equipment, wherein the apparatus comprises:
a clock input selection module;
a clock input distributing module;
wherein the clock input selection module provides an input interface to receive clock input signals from the primary and the redundant system, wherein the clock input selection module selects the clock input signal received from the primary system, wherein the selected clock input signal is sent to the clock input distributing module, and wherein the clock input distributing module distributes the received clock input signal and outputs the distributed signals.

4. The apparatus of claim 3, wherein the clock input selection module is connected to a clock selection control module, wherein the clock selection control module generates and sends a clock selection control signal to the clock input selection module, and wherein the clock selection control module generates the clock selection control signal according to a state signal from the primary and the redundant system.

5. The apparatus of claim 3, wherein the clock input selection module comprises a SY100EL56V chip, and wherein the clock input distributing module comprises a SY100EL11V chip.
